(19) United States
(12) Patent Application Publication
(10) Pub. No.: US 2010/0220067 A1
(43) Pub. Date: Sep. 2, 2010

(54) PORTABLE ELECTRONIC DEVICE WITH A MENU SELECTION INTERFACE AND METHOD FOR OPERATING THE MENU SELECTION INTERFACE

(75) Inventor: CHENG-KUO YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Foxconn Communication Technology Corp., Taoyuan County (TW)

(21) Appl. No.: 12/535,786

(22) Filed: Aug. 5, 2009

(30) Foreign Application Priority Data
Feb. 27, 2009 (CN) 200910300603.2

(51) Int. Cl. G06F 3/041; G06F 3/048

(52) U.S. Cl. 345/173; 715/835

(57) ABSTRACT

A portable electronic device and a method for operating a menu selection interface of the portable electronic device are provided. The menu selection interface is displayed on a touch-sensitive display of the portable electronic device. The method generates a sensing signal when a menu item of the menu selection interface is touched, and analyzes the sensing signal to determine a touched menu item of the menu selection interface. The method further generates a first responsive signal according to the touched menu item, and displays menu icons of the touched menu item on the touch-sensitive display when the first responsive signal is received. In addition, the method generates a second responsive signal when one of the menu icons is selected, and executes a function action corresponding to the selected menu icon when the second responsive signal is received.

### BACKGROUND

1. Technical Field

Embodiments of the present disclosure relate to user interfaces, and more particularly to a portable electronic device with a menu selection interface and method for operating the menu selection interface.

2. Description of Related Art

As portable devices have become more compact, and the amount of information to be processed increases, it has become a significant challenge to design a user interface that allows users to easily interact with the portable devices. Some conventional user interfaces may result in complicated key sequences or menu hierarchies that must be memorized by the user. These conventional user interfaces may also result in time consuming required to memorize the multiple key sequences or menu hierarchies. In particular, the required behaviors during the process of operating such conventional user interfaces are often counter intuitive and the corresponding indicators guiding user actions are often difficult to understand.

Accordingly, there is a need for an intuitive user interface for a portable electronic device that enables a user to conveniently operate a desired menu items in the user interface.

### BRIEF DESCRIPTION OF THE DRAWINGS

FIG. 1 is a schematic diagram of one embodiment of a portable electronic device with a menu selection interface.

FIG. 2 is a flowchart of one embodiment of a method for operating a menu selection interface of the portable electronic device as described in FIG. 1.

FIG. 3A-3C are schematic diagrams illustrating one embodiment of a menu selection interface during operating the menu selection interface.

FIG. 4 is a flowchart of another embodiment of a method for operating a menu selection interface of the portable electronic device as described in FIG. 1.

FIG. 5A-5C are schematic diagrams illustrating another embodiment of a menu selection interface during operating the menu selection interface.

### DETAILED DESCRIPTION

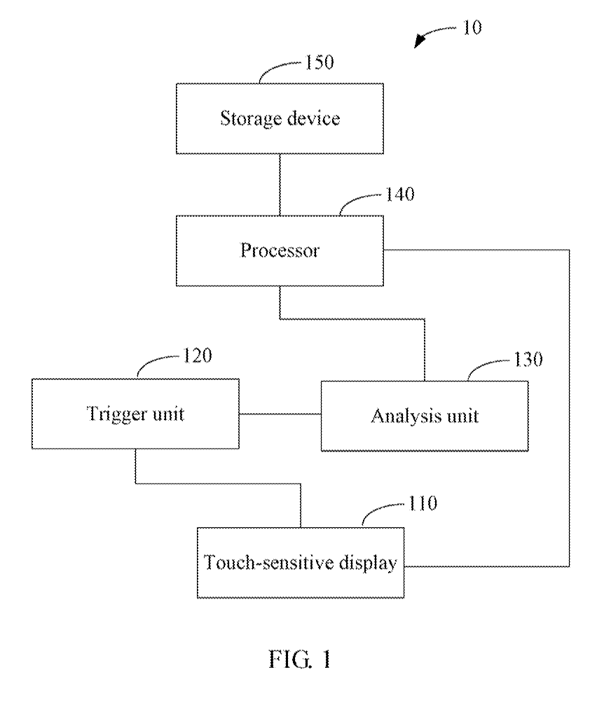

FIG. 1 is a schematic diagram of one embodiment of a portable electronic device 10 with a menu selection interface. In one embodiment, the portable electronic device 10 may include a touch-sensitive display 110, a trigger unit 120, an analysis unit 130, at least one processor 140, and a storage device 150. These components may be coupled by one or more communication buses or signal lines. The portable electronic device 10 can be a handheld computer, a tablet computer, a mobile phone, a media player, and a personal digital assistant (PDA), for example. It should be apparent that FIG. 1 is only one example of an architecture for the portable electronic device 10 that can be included with more or fewer components than shown, or a different configuration of various components. The various components shown in FIG. 1 can be implemented in hardware, software, or a combination of both hardware and software. The at least one processor 140 runs various software components stored in the storage device 150 to perform various functions for the portable electronic device 10.

The touch-sensitive display 110 is operable to display a menu selection interface that includes at least one menu item. Each of the menu items corresponds to a plurality of menu icons, and each of the menu icons corresponds to an application program or instructions that are stored in the storage device 150. In one embodiment, each of the menu icons may be a logo, one or more characters, or a combination of the logo and the one or more characters. In one example, the storage device 150 may be a flash-based memory, or an erasable programmable read-only memory (EPROM).

The trigger unit 120 is operable to generate a sensing signal when one of the menu items of the menu selection interface is actuated/touched. In one embodiment, each of the menu items is touchable using a stylus, a finger or more than one finger. The sensing signal is used to determine which menu item is touched. For example, the user may touch a menu item on the touch-sensitive display 110, the trigger unit 120 generates a sensing signal corresponding to the menu item, thereby the touched menu item is determined according to the sensing signal.

The analysis unit 130 is operable to receive the sensing signal from the trigger unit 120, and analyze the sensing signal to determine a touched position of the touch-sensitive display 110. The analysis unit 130 is further operable to determine a touched menu item of the menu interface according to the touched position, and generate a first responsive signal and a second responsive signal. In one embodiment, the analysis unit 10 generates the first responsive signal when the menu item is touched, and sends the first responsive signal to the processor 140 for displaying a plurality of menu icons corresponding to the touched menu item on the touch-sensitive display 1 10. When one of the menu icons is touched, the analysis unit 10 generates the second responsive signal, and sends the second responsive signal to the processor 140 for executing a function action corresponding to the menu icon.

The processor 140 is operable to display the menu icons corresponding to the touched menu item when the first responsive signal is received, and execute the function action corresponding to the selected menu icon when the second responsive signal is received. The processor 140 is further operable to control the untouched menu items to disappear from the menu selection interface or hide from the menu selection interface when the first responsive signal is received.

When the menu icons are displayed on the touch-sensitive display 110, the user can select a desired menu icon. If one of the menu icons is selected, the processor 140 executes the function action corresponding to the selected menu icon. If no menu icon is selected, the user can stop touching the menu item on the menu selection interface. In this situation, the processor 140 controls the menu icons to hide from the menu selection interface, and redisplay the untouched menu items on the menu selection interface.

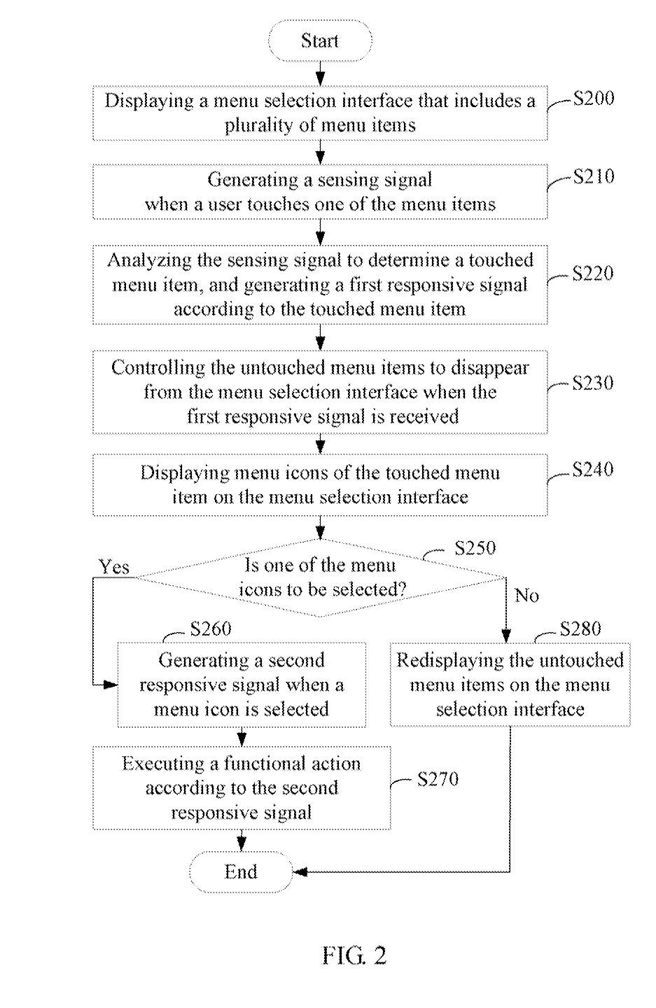

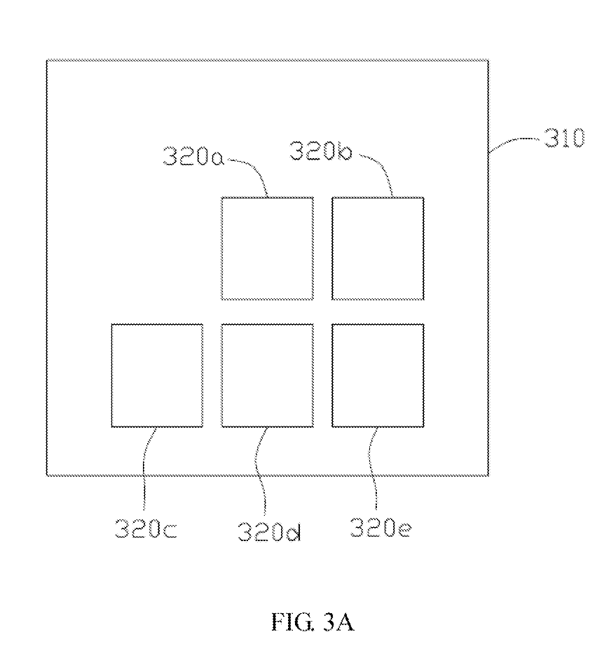

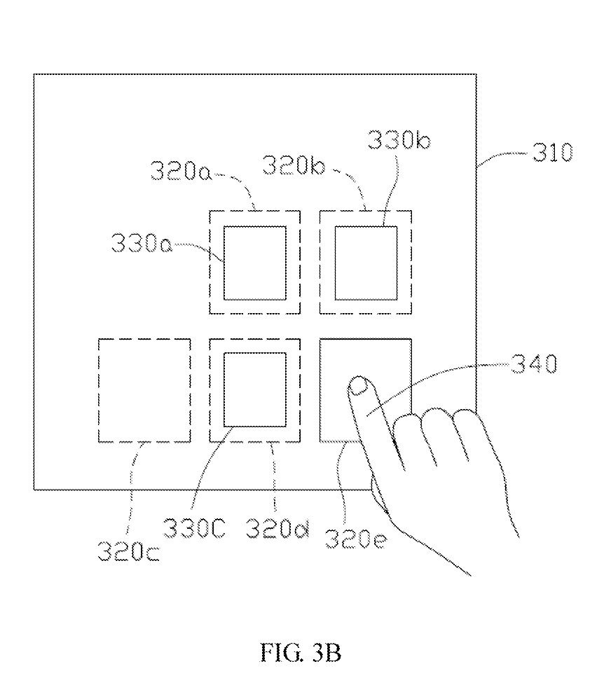

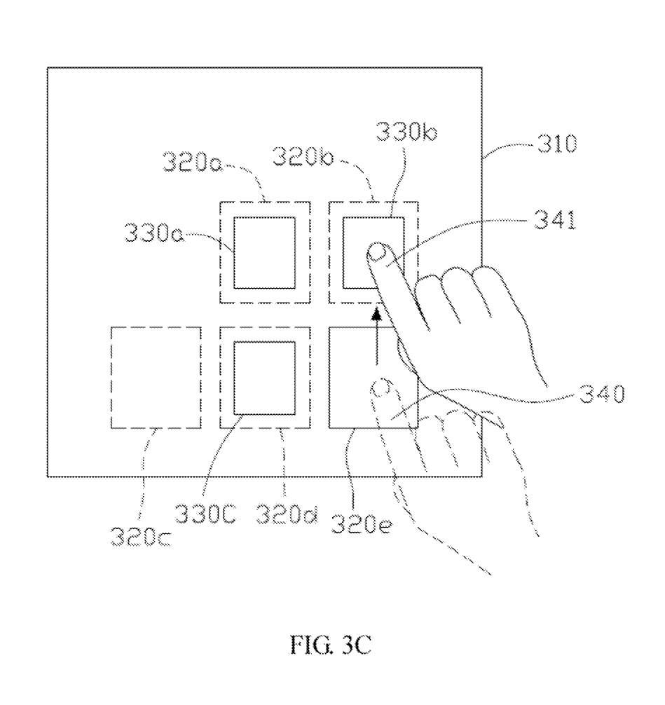

FIG. 2 is a flowchart of one embodiment of a method for operating a menu selection interface of the portable electronic device 10 as described in FIG. 1. Depending on the embodiment, additional blocks may be added, others removed, and the ordering of the blocks may be changed. For a better understanding of the embodiment, FIG. 3A-FIG 3C should be made to describe the method as follows. FIG. 3A-3C are schematic diagrams illustrating one embodiment of a menu selection interface during operating the menu selection interface.

In block S200, the touch-sensitive display 110 displays a menu selection interface 310 that includes a plurality of menu items 320a-320e. Referring to FIG. 3A, each of the menu items 320a-320e is displayed on the menu selection interface 310. In one embodiment, each of the menu items 320a-320e may be a logo, one or more characters, or a combination of the logo and the one or more characters.

In block S210, the trigger unit 120 generates a sensing signal when a user touches one of the menu items 320a-320e of the menu selection interface 310. Referring to FIG. 3B, the trigger unit 120 generates the sensing signal when the user touches a position 340 of touch-sensitive display 110. In one embodiment, the user may touch the menu item of the menu selection interface by using a stylus, a finger or more than one finger.

In block S220, the analysis unit 130 analyzes the sensing signal to select a menu item 320e of the menu selection interface 320 according to the touched position 340, and generates a first responsive signal according to the touched menu item 320e.

In block S230, the processor 140 controls the untouched menu items 320a-320d to disappear from the menu selection interface 310 when the processor 140 receives the first responsive signal from the analysis unit 130. In block S240, the processor 140 controls the touch-sensitive display 110 to display a plurality of menu icons corresponding to the selected menu items 320e. Referring to FIG. 3B, the untouched menu items 320a-320d are disappeared from the menu selection interface 310 when the first responsive signal is received, and the menu icons 330a-330c are displayed on the menu selection interface 310.

In block S250, the user determines whether one of the menu icons 330a-330c is desired to be selected. Referring to FIG. 3C, if a menu icon 330b is desired to be selected, in block S260, the analysis unit 130 generates a second responsive signal, and transmits the second responsive signal to the processor 140. In block S270, the processor 140 executes a function action corresponding to the selected menu icon 330b when the second responsive signal is received.

Otherwise, if none of the menu icons 330a-330c is desired to be selected, in block S280, the processor 140 controls the untouched menu items 320a-320d to redisplay on the menu selection interface 310 when the user stops touching the menu item 320e.

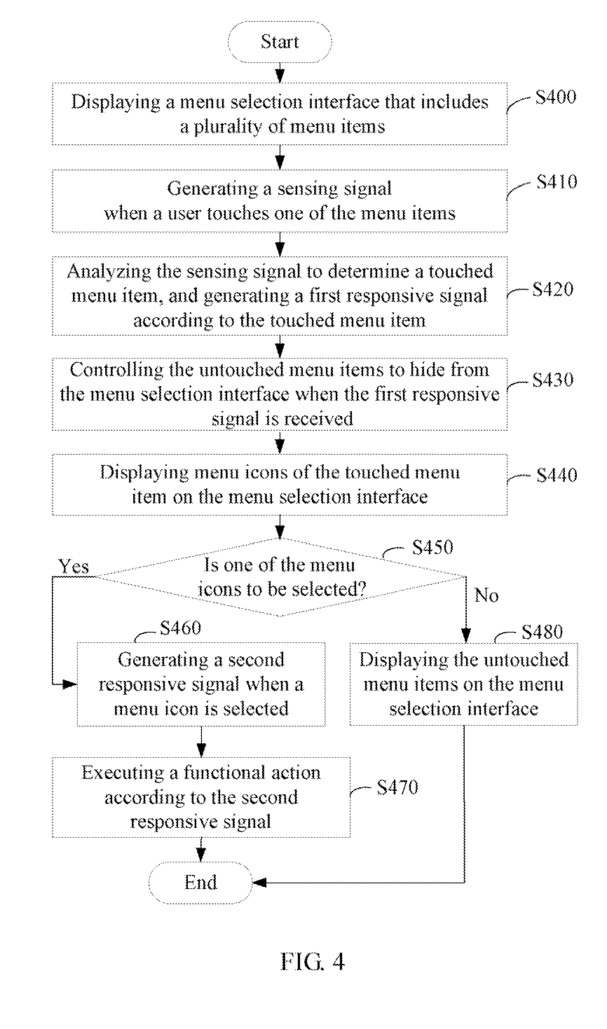

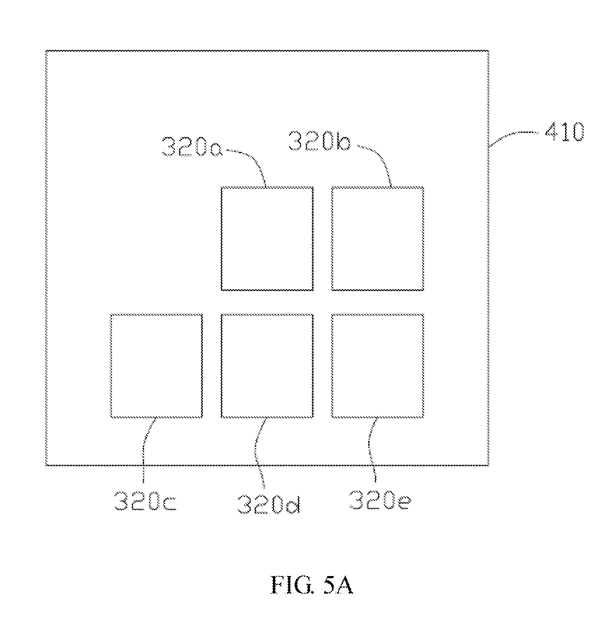

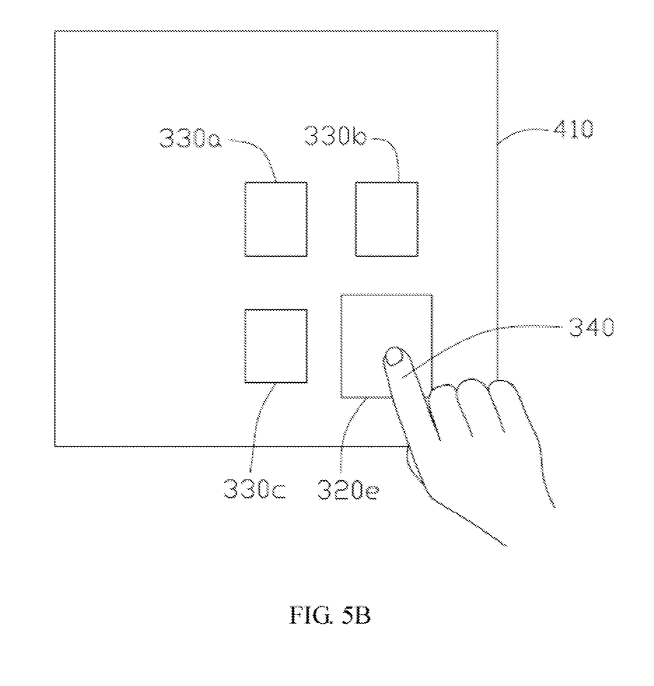

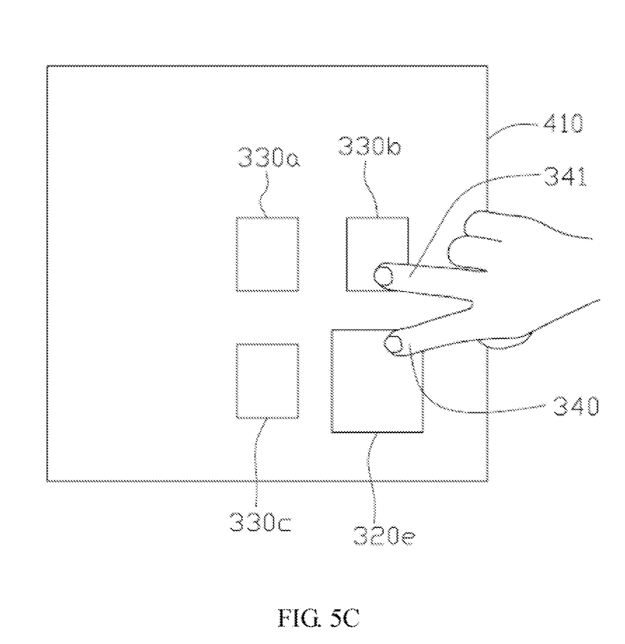

FIG. 4 is a flowchart of another embodiment of a method for operating a menu selection interface of the portable electronic device 10 as described in FIG. 1. Depending on the embodiment, additional blocks may be added, others removed, and the ordering of the blocks may be changed. For a better understanding of the embodiment, FIG. 5A-FIG. 5C should be made to describe the method as follows. FIG. 5A-5C are schematic diagrams illustrating another embodiment of a menu selection interface during operating the menu selection interface. The procedures of FIG. 4 are the same as those described above in relation to FIG. 2, except for replacing block S230 with block S430 as described below, and replacing block S280 with S480 as described below.

In block S430, the processor 140 controls the untouched menu items 320a-320d to hide from the menu selection interface 410 when the first responsive signal is received. Referring to FIG. 5B, the untouched menu items 320a-320d are hidden from the menu selection interface 410 when the first responsive signal is received, and the menu icons 330a-330c are displayed on the menu selection interface 410.

In block S480, if none of the menu icons 330a-330c is desired to be selected, the processor 140 controls the untouched menu items 320a-320d (see FIG. 5A) to redisplay on the menu selection interface 410 when the user stops touching the menu item 320e. Referring to FIG. 5C, when a menu icon 330b is selected by the user, a function action corresponding to the selected menu icon 330b is executed by the processor 140.

All of the processes described above may be embodied in, and fully automated via, various functional components executed by one or more general purpose processors of electronic devices. The functional components may be stored in any type of a computer-readable medium or other storage devices. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A portable electronic device, comprising:
a touch-sensitive display operable to display a menu selection interface comprising at least one menu item, each menu item corresponding to a plurality of menu icons;
a trigger unit operable to generate a sensing signal when a menu item of the menu selection interface is touched;
an analysis unit operable to determine a touched position of the touch-sensitive display by analyzing the sensing signal, determine a touched menu item of the menu selection interface according to the touched position, generate a first responsive signal according to the touched menu item, and generate a second responsive signal when one of the menu icons is selected; and
a processor operable to control the touch-sensitive to display the menu icons corresponding to the touched menu item when the first responsive signal is received, and execute a function action corresponding to the selected menu icon when the second responsive signal is received.

2. The portable electronic device according to claim 1, wherein the processor is further operable to control the untouched menu items to disappear from the menu selection interface when the first responsive signal is received.

3. The portable electronic device according to claim 1, wherein the processor is further operable to control the untouched menu items to hide from the menu selection interface when the first responsive signal is received.

4. The portable electronic device according to claim 1, wherein the processor controls the menu icons to hide from the menu selection interface and display the untouched menu items on the menu selection interface when none of the menu icons has been selected.

5. The portable electronic device according to claim 1, wherein each of the menu icons is selected from the group consisting of a logo, one or more characters, or a combination of the logo and the one or more characters.

6. The portable electronic device according to claim 1, wherein each of the menu icons corresponds to an application program that is stored in a storage device, and the function action is performed by the application program.

7. A method for operating a menu selection interface of a portable electronic device, the method comprising:
displaying a menu selection interface on a touch-sensitive display of the portable electronic device, the menu selection interface comprising at least one menu item, each menu item having a plurality of menu icons;
generating a sensing signal when a menu item of the menu selection interface is touched;
analyzing the sensing signal to determine a touched position of the touch-sensitive display;
determining a touched menu item of the menu selection interface according to the touched position;
generating a first responsive signal according to the touched menu item;
displaying the menu icons of the touched menu item on the touch-sensitive display when the first responsive signal is received;
generating a second responsive signal when one of the menu icons is selected; and
executing a function action corresponding to the selected menu icon when the second responsive signal is received.

8. The method according to claim 7, further comprising:
controlling the untouched menu items to disappear from the menu selection interface when the first responsive signal is received; or
controlling the untouched menu items to hide from the menu selection interface when the first responsive signal is received.

9. The method according to claim 7, further comprising:
controlling the menu icons to hide from the menu selection interface and displaying the untouched menu items on the menu selection interface when none of the menu icons has been selected.

10. The method according to claim 7, wherein each of the menu icons corresponds to an application program that is stored in a storage device, and the function action is performed by executing the application program corresponding to the selected menu icon.

11. The method according to claim 7, wherein each of the menu icons is selected from the group consisting of a logo, one or more characters, or a combination of the logo and the one or more characters.

12. A storage medium having stored thereon instructions that, when executed by at lease one processor of a portable electronic device, cause the portable electronic device to perform a method, the method comprising:
displaying a menu selection interface on a touch-sensitive display of the portable electronic device, the menu selection interface comprising at least one menu item, each menu item having a plurality of menu icons;
generating a sensing signal when a menu item of the menu selection interface is touched;
analyzing the sensing signal to determine a touched position of the touch-sensitive display;
determining a touched menu item of the menu selection interface according to the touched position;
generating a first responsive signal according to the touched menu item;
displaying the menu icons of the touched menu item on the touch-sensitive display when the first responsive signal is received;
generating a second responsive signal when one of the menu icons is selected; and
executing a function action corresponding to the selected menu icon when the second responsive signal is received.

13. The storage medium according to claim 12, wherein the method further comprises:
controlling the untouched menu items to disappear from the menu selection interface when the first responsive signal is received; or
controlling the untouched menu items to hide from the menu selection interface when the first responsive signal is received.

14. The storage medium according to claim 12, wherein the method further comprises:
controlling the menu icons to hide from the menu selection interface and displaying the untouched menu items on the menu selection interface when none of the menu icons has been selected.

15. The storage medium according to claim 12, wherein each of the menu icons corresponds to an application program that is stored in a storage device, and the function action is performed by executing the application program corresponding to the selected menu icon.

16. The storage medium according to claim 12, wherein each of the menu icons is selected from the group consisting of a logo, one or more characters, or a combination of the logo and the one or more characters.
